(19) United States
(12) Patent Application Publication
(10) Pub. No.: US 2004/0210486 A1
(43) Pub. Date: Oct. 21, 2004

(54) Internet payment enabling device for vending machines

(76) Inventor: Giovanni Carapelli, Firenze (IT)

Correspondence Address: Eitan Peart, Latzer & Cohen Zedek, Suite 1001, 10 Rockefeller Plaza, New York, NY, 10020, US

(21) Appl. No.: 10/483,431

(22) PCT Filed: Nov. 14, 2001
(86) PCT No.: PCT/IB01/02758

(30) Foreign Application Priority Data
Nov. 14, 2000 (EP) 00124784.0

(51) Int. Cl. G06F 17/60

(52) U.S. Cl. 705/16

(57) ABSTRACT

An Internet payment enabling device (1) for a vending machine (2) for selling products or services to a purchaser having a mobile communicator enabled to a wireless internet connection comprises: a communication interface (7) with a vending machine (2); computer means (3) able to support transmission through the Internet (20) of data identifying said vending machine (2); a connection (10) for the transmission/reception of said data to and from a remote Internet operator (17) and means to notify a purchaser identifying data (9) of the vending machine (2).

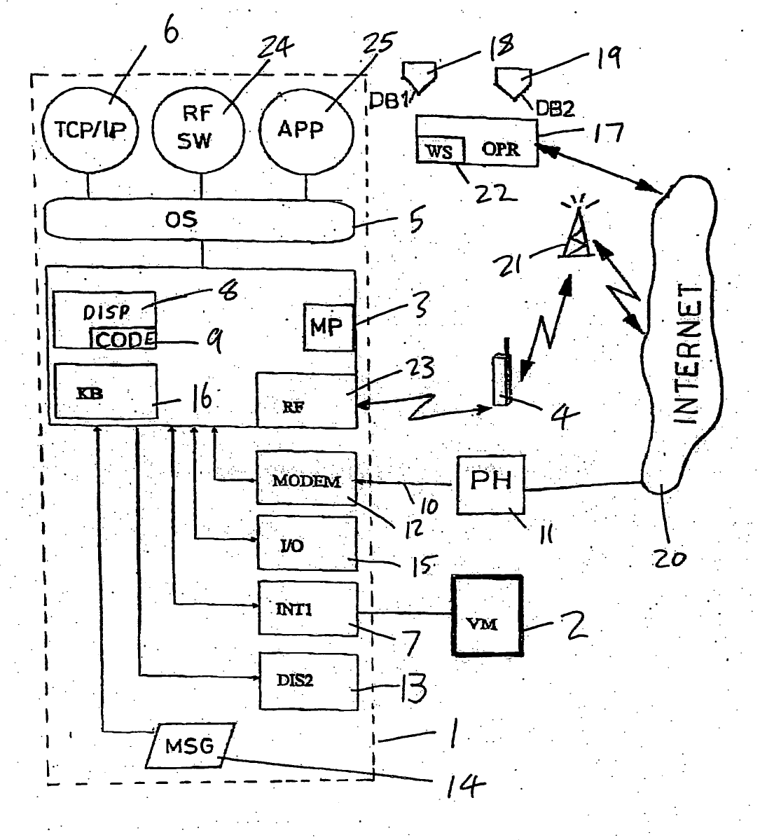

### BACKGROUND OF THE INVENTION

At present several vending systems are already known, in particular the so called “self service” systems (e.g. Auto Teller Machine (ATM) and “Point Of Sale” (POS) systems) by which a vendor is connected to a remote banking operator and is able to sell a product or a service to a purchaser paying by credit/debit card.

These known systems present some drawbacks due to the fact that they have to be directly connected to a financial operator which guarantees the payment. Furthermore, the existing POS's save to be certified in order to guarantee the security of the payment and of the transaction procedures, which are processed by the same POS device.

From the point of view of the customers of a POS, a further problem of existing devices is that a customer has to first insert his credit card into a slot of the POS device, then directly communicate to the POS his credit card PIN number. Consequently, the customer is exposed, as actually often happens, to risks of a fraudulent use of the same number.

A further drawback of the existing vending devices is that they have to be equipped with complicated and costly mechanical devices (such as card readers), which need maintenance and are difficult to be upgraded to use new or different payment systems.

### AIM OF THE INVENTION

Aims of the invention are to overcome the limits of the conventional vending systems, allowing vendors to sell goods and services in a secure manner in real time to customers having internet enabled wireless communicators, whilst protecting customers from fraudulent use of personal data transmitted to the payment system.

### SUMMARY OF THE INVENTION

According to the present invention there is provided on internet payment enabling device for a vending machine for selling products or services to purchasers having a mobile communicator enabled to a wireless internet connection, the device comprising:

a communication interface with at least a vending machine;

computer means able to support transmission through the Internet of data identifying said vending machine;

a connection for the transmission/reception of said data to and from a remote Internet operator;

means to notify a purchaser identifying data of the vending machine.

A first advantage of employing the present invention is that it permits, in a easy and inexpensive way, both existing and new vending machines, such as POS or similar devices, to access internet technologies and thus the specific improvements that such technologies bring in terms of the security of the payment system.

A further advantage of the invention is that an efficient and reliable diagnostic control of the payment procedures can be implemented in a simple manner even with existing vending machines. Also the security of the payment procedures is increased and “transferred” from the vending machine to the mobile communicator of the customer.

A still further advantage is that it is possible to upgrade the device of the invention from a remote centre, so at when a different payment procedure has to be adopted it is not necessary to modify the composition of the device.

A still further advantage is that any mobile phone can be enabled to a plurality of remote credit operators connected with the device of the invention.

### BRIEF DESCRIPTION OF DRAWING

One embodiment of the present invention will now be described by way of example only with reference to the accompanying figure.

### DETAILED DESCRIPTION OF THE INVENTION

With reference to the attached Figure, an internet payment enabling device 1 for a vending machine 2 is shown which comprises:

a microprocessor unit 3 able to support Internet data transmission to and from a mobile Internet enabled communicator such as a WAP enabled cellular phone 4. Microprocessor 3 is controlled by a multitasking operating system 5 (for example LINUX) supporting a data transmission based on the TCP/IP protocol 6;

a communication interface 7 connected to a vending machine 2. This may be a serial connection, or a bi-directional communication cable. The vending machine 6 may be an ATM, POS, retailing machine or personal computer when used to buy on line;

a display 8 to display a code 9 to a customer having a mobile communicator 4 enabled to an internet transmission protocol, which display 8 the purchaser can read when in the vicinity of the internet payment enabling device connected to the vending machine 2. Depending on the architecture of vending machine, said display can also be part of the vending machine and the code 9 can be transmitted to the vending machine through the interface 7;

a connection 10 to a phone line 11. Preferably the connection consists of a ISDN or analogue modem 12 or a wireless connection;

optionally a service display 13;

optionally a service signal output 14;

optionally input/output connections 15;

optionally a service keyboard 16.

Said means 8 to make available a code 9 to a customer can consist of a display of the enabler, to display the code 9.

According to the invention, an internet operator 17 (for example an Internet banking operator) is provided with a first database 18 containing identifying data of the vending machines of the system and a second database 19 containing identifying data of customers authorised to make a purchase.

Preferably, said first database 18 stores identifying data of the vending machines as identity numbers with the Internet address of each vending machine.

The identifying data of database 19 comprises customer identity numbers and other account data that can be utilised to authorise a purchase to that customer.

In operation, the internet payment enabling device 1 is connected to vending machine 2 through the interface 6 and it sends to the operator 17, via the Internet connection 10 to the internet 20, a message containing an IP address to be associated with the vending machine 2 along with the identifying data of the vending machine 2 (which are stored by operator 17 in database 18).

The operator 17 then returns to the internet payment enabling device 1 a message containing a code 9 which code will be notified to the customer to perform a payment and also used by operator 17 to associate the requested payment to the correct vending machine and customer.

When a customer provided with a communicator 4 wishes to request to an operator 17 a payment, the communicator 4 connects to the internet through a network access point 21, in order to communicate with the operator 17 by web server 22 of the operator, preferably using an internet “bookmark” on the communicator 4.

Preferably, in order to guarantee the customer from a possible accidental payment order the code transmitted from the operator 17 to the Internet payment enabling device changes after each payment request.

When the purchaser having a suitable communicator 4 is in the vicinity of a vending machine 2 he can read the identifying code 8 corresponding to that machine. The communicator 4 is then caused to transmit from an internal secure memory location to the web server 22 a customer ID, so that the operator 17 can verify whether the customer is a purchaser already identified in the second database 19.

Once the purchasers identity has been verified the operator 17 asks the customer to transmit the corresponding code 9 associated with the vending machine 2. The operator 17 receives the code 9 and associates it to the corresponding IP address of the vending machine 2, both contained in the data base 18, so that it can check, for example, the functioning state of the vending machine 2 and to authorise the same to make a transaction.

Accordingly, the vending machine will be commanded by the operator 17, through the internet payment enabling device 1, to accept the payment, and subsequently the purchaser will be invoiced the corresponding cost and a message of completion of the sale procedure can be displayed on the communicator display, for example in the form of a SMS message which will act as a receipt of the transaction.

Analogously, a receipt of successful payment will be sent from the operator 17 to the vendor and stored and/or printed by an optional printer of the vending machine 2.

Advantageously, the communication, both to and from the operator 17 and to and from the communicator 4, are protected by encryption codes (for example SSL) and hence all the connected devices communicate in a secure manner for example through a Public key infrastructure (PKI).

The display 8 to make code 9 available to a customer could alternatively consist of a bi-directional radio frequency (RF) interface 23 supporting communication with communicator 4 based on Internet protocol. Preferably, in this embodiment RF interface 23 is able to automatically connect the communicator 4 with the internet payment enabling device 1 when the customer is close to the vending machine with which it is associated.

A suitable RF interface is a Bluetooth™ enabled interface and a suitable communicator 4 is then a WAP and Bluetooth™ enabled cellular phone. In this case, the Internet payment-enabling, device is provided with suitable software RFSW 24 able to control the Bluetooth™ interface.

Advantageously, in this embodiment the RF interface automatically transmits the code 9 to the customer facing vending machine 2, so that once connected through the Internet with the operator 17, the customer will have only to ask for a transaction authorisation.

As a further advantage, in this case the vending machine does not need a display, nor a printer to supply, a receipt (given by the system in the form of a SMS message on the user handset) and the user interface comprises only the customer communicator 4.

In a further embodiment of the system the Internet access point of the Internet payment-enabling device 1 is the same as the above described radio frequency interface 21 but connected to the internet 20 through a suitable connection. In this case the user can access the Internet 20 and connect to the web server 22 of the operator 17 “through” the RF interface 21.

In order to permit the owner of the vending machine 2 to restrict the Internet access of the user only to the connection to certain IP addresses (for example a number of authorisation centres) it is possible to encrypt these connections by suitable encryption protocols.

The Internet payment-enabling device can consist of an electronic card to be connected to a card slot of a Personal Computer connected to a remote banking operator. In this case the card is provided with a tamper roof area comprising a microprocessor unit having the above described features, where the interface 7 with the vending machine is the usual connection of the card with the PC architecture, for example a BUS connection, while INT2 can be a code visualised by the display of the PC or again a radio frequency interface of the above described kind.

In view of the above, it is evident that by equipping a vending machine 2 with the Internet payment-enabling device 1 of the invention, the latter operates the payment routing through a suitable Payment Software Agent (APP) 25 run by the microprocessor 3. Thus the internet payment enabling device acts like a “bridge” between a user and a remote operator, while the security features, previously included in the conventional POS device (or in the equivalent vending machine), are embedded in the mobile communicator of the customer and are guaranteed by encrypted communication protocols. It is then sufficient to protect the microprocessor 3 (for example by sealing with resin the relevant area) to achieve a substantially tamper-proof payment system where the software is protected by the protection of the internet payment enabling device electronic equipment, and the communication security from the customer and the remote operator is guaranteed by the encryption protocols utilised by the mobile digital communicators.

The present invention has been described with reference to preferred embodiments, however equivalent modifications can be made within the scope of the appended claims.

As an example, the enabler of the invention previously described as a separate “box” to be connected to existing vending machines, can be embedded into a new apparatus having both the features of the enabler and the features of a conventional vending machine.

1. An Internet payment enabling device (1) for a vending machine (2) for selling products or services to purchasers having a mobile communicator (4) enabled to a wireless internet connection, the device comprising:
a communication interface (7) to a vending machine (2);
computer means (3) able to support transmission through the Internet (20) of data identifying said vending machine (2);
a connection (10) for the transmission/reception of data to and from a remote Internet operator (17);
means to notify a purchaser of data identifying the vending machine;

2. A device according to claim 1, wherein said computer means comprises a microprocessor unit (3) supporting a data transmission program based on the TCP/IP protocol (6).

3. A device according to claim 1 or 2, wherein said connection (10) comprises an ISDN or analogue modem (12) to a phone line (11).

4. A device according to claim 1 or 2, wherein said connection consists of a wireless bi-directional connection supporting Internet transmission protocols.

5. A device according to any preceding claim wherein said means to notify a purchaser comprises a display (8) able to visually display a code (9) identifying vending machine (2).

6. A Device according to any one of claims 1 to 4, wherein said means to notify a purchaser comprises a radio frequency bi-directional interface (23) able to automatically establish a connection with a mobile communicator (4) of a purchaser in the vicinity of the vending machine (2) and to transmit to the purchaser a code (9) identifying the vending machine (2).

7. A device according to any preceding claim, wherein said vending machine (2) is a personal computer (PC) connectable with a remote Internet operator (17), for payment of products or services, wherein:
said computer means (3) comprises an electronic card arranged to be inserted into a slot of said personal computer;
said interface (7) comprises the connections of the card slot to the personal computer;
said connection (10) is constituted by a modem connection of the card to a phone line (11); and
said means (8) to notify a purchaser identifying data of the vending machine are constituted by a display of the personal computer displaying a code (9).

8. A device according to claim 7, wherein said computer means is a protected anti-taper area of the card.
